(19) United States
(12) Patent Application Publication
(10) Pub. No.: US 2016/0190672 A1
(43) Pub. Date: Jun. 30, 2016

(54) Method and Assembly for Radio-Frequency (RF) Power Coupling

(71) Applicant: OOO Siemens, Moscow (RU)

(72) Inventors: Alexey GUDOVICH, Moscow (RU); Andrey KRASNOV, Moscow (RU); Konstantin NIKOLSKIY, Ivanteevka (RU); Alexander SMIRNOV, Moscow (RU)

(73) Assignee: OOO Siemens, Moscow (RU)

(21) Appl. No.: 14/911,321

(22) PCT Filed: Aug. 15, 2013
(86) PCT No.: PCT/RU2013/000708

§ 371 Date: Feb. 10, 2016

(51) Int. Cl. H01P 5/12; H01P 1/30

(52) U.S. Cl. CPC H01P 5/12; H01P 1/30

(57) ABSTRACT

A method and an assembly for radio-frequency (RF) power coupling in a rack includes at least one box shaped power combiner and/or divider, connectors for inputting and outputting RF-power, conductors arranged inside the at least one box shaped power combiner and/or divider, electrically connecting the connectors with at least one center conductor, and at least one outside conductor formed as a box shaped casing.

### CROSS-REFERENCE TO RELATED APPLICATIONS

This is a U.S. national stage of application No. PCT/RU2013/000708 filed 15 Aug. 2013.

### BACKGROUND OF THE INVENTION

1. Field of the Invention

The present invention relates to a method and assembly for radio-frequency power coupling, comprising at least one box shaped power combiner and/or divider, with connectors for input and output of RF-power, with conductors inside the box, electrically connecting the connectors with at least one center conductor, and with at least one outside conductor.

2. Description of the Related Art

Power dividers are used to divide RF power from single RF generators to multiple recipients. Power combiners are used to combine RF power from multiple sources to feed a single recipient with additional power. Recipients receiving RF power are, for example, loads or antennas. Most devices used as power divider or power combiner are also work reciprocally, i.e., they can be used both as a divider and as a combiner. In the following, the use of the wording divider includes the use of a combiner and the use of the wording combiner includes the use of a divider. The main parameters for combiner/divider design in terms of RF-power handling are heat and breakdown voltage.

Requirements in use are the transmission of RF-power with low insertion and return loss. Further requirements are compactness, easy assembly and cost effective, easy manufacturing.

There are two main types of conventional power combiners/dividers, e.g., based on printed circuit boards (PCB) or coaxial based combiners/dividers. PCB based combiners/dividers are mainly used in low power applications. Low power in this context is in the range of a couple of kilowatts in continuous wave regime to approximately ten kilo-watts in pulsed mode use. PCB based devices are quite compact but are not for use in high power applications. Coaxial based combiners/dividers are usable for low power applications and for extremely high power levels, particularly up to hundreds of kilowatt. A disadvantage of coaxial based combiners/dividers is the lack of compactness, i.e., high volume respectively size.

A conventional combiner, e.g., as described in U.S. Pat. No. 4,459,568, is an air-stripe coupler. Here, power propagates in the gap between two strip lines. The device contains PCB, which does not enable high voltage use.

US 2012/029327 discloses a conventional power combiner/divider that permits high power signals. This conventional power combiner/divider is relatively large in size and is not compact, and due to its cylindrical shape it cannot be used in racks. There is excessive empty space within the structure of the power combiner/divider.

U.S. Pat. No. 5,111,166 discloses an electrical length equalization system for multiple inputs with inter alia power combining applications. Due to its PCB basing, this system can only be used in low power applications. Further, the handling and manufacturing or the system is not easy. The assembly comprises a complicated structure.

### SUMMARY OF THE INVENTION

In view of the foregoing, it is an object of the present invention to provide a compact assembly for radio-frequency power coupling, which is easy to assemble and manufacture at low cost, and which can be used in high power applications. A further object of the present invention is to provide a method for using the assembly in a compact way.

These and other objects and advantages are achieved in accordance with the invention by providing a method assembly for radio-frequency power coupling, where the assembly for radio-frequency (RF) power coupling in accordance with the present invention comprises at least one box shaped power combiner and/or divider, with connectors for input and output of RF-power, with conductors inside the box, electrically connecting the connectors with at least one center conductor, and with at least one outside conductor. In accordance with the present invention, at least one outside conductor is a box shaped casing.

The shape of a box enables a compact assembly for radio-frequency power coupling. The simple structure of the power combiner and/or divider is easy to assemble and manufacture, at low cost. The power combiner and/or divider can be used in high power applications.

The box shaped casing can be a parallelepiped, particularly a cuboid. This enables an easy storage in racks, and a compact assembly of power combiners and/or dividers. Not much space is needed or lost by no close fitting of outer shapes.

Parts, particularly all parts of the at least one box shaped power combiner and/or divider, can be made of solid metal pieces.

The parts can comprise or consist of copper, aluminum and/or steel with copper coating. This also enables low as well as high power applications and a low level of electrical, resistive and/or frequency losses within the power combiners and/or dividers.

The at least one box shaped power combiner and/or divider can comprise at least one power combining or dividing part (A) and at least one impedance transforming part (B). The impedance transforming part (B) can be a narrow band or a wideband frequency element. The at least one box shaped power combiner and/or divider can be a RF matching element for reducing the reflection of RF power, particularly between multiple 50 Ohm coaxial connectors at one side and a single 50 Ohm connector at the other side of the at least one box shaped power combiner and/or divider.

The impedance transforming part (B) can be an electrical conduction line with an outer stepped, tapered or binomial shape.

The shape depends on application, power and frequency used and can be optimized to reduce power loses and produced heat.

The at least one box shaped power combiner and/or divider can comprise at least one coaxial, at least one rectangular waveguide, and/or at least one circular waveguide connector. The connector depends on the special application, frequency and power as well as on the kind of connected devices of the respective power combiner and/or divider. Corresponding connection lines can be used to connect with other devices.

The at least one box shaped power combiner and/or divider can have substantially the dimension of a 19-inch rack, particularly with a module front panel wide of 482.6 mm. This makes an easy use possible, because 19-inch racks are the most commonly used racks in electronic applications and for devices. It enables a very compact rack in combination together with other standard components.

The at least one box shaped power combiner and/or divider can comprise at least one fluid, particularly a water cooling device. The cooling can be necessary in high power applications, in order to remove waste heat from the power combiner. Water cooling elements can be arranged inside the center conductor. It can have inlets on the same side of the outside conductor, which has the form of a box shaped casing, as the side the input/output RF connectors are arrange to. That prevents the water cooling system from penetrating the inner space of the power combiner and/or divider, and perturbing the RF features of the power combiner and/or divider. It increases the maximal possible operational RF power to be used with the power combiner and/or divider.

The at least one center conductor can be in the form of a flat plate, particularly arranged parallel to a ground plane of the at least one box shaped power combiner and/or divider.

As a result, a very compact assembly and small sized power combiner and/or divider is attained.

The conductors inside the box, electrically connecting the connectors with the at least one center conductor, can be in the form of rods, particularly solid bent rods with round and/or rectangular cross-section. A good electrical conduction with low resistive losses and high frequency transfer from multiple connectors for RF-power to the central conductor is possibly with this assembly. Low losses cause little waste heat to be removed. This enables them to work without or with only a small cooling system.

The method in accordance with the present invention for using an assembly for radio-frequency (RF) power coupling, particularly with an assembly as described before, comprises the stacking of box shaped power combiners and/or dividers, particularly in a 19-inch rack next and/or on top of each other.

The advantages in connection with the described method of using an assembly for radio-frequency (RF) power coupling in accordance with the present invention are similar to the previously, in connection with the assembly for radio-frequency (RF) power coupling described advantages and vice versa. Particularly, the compact assembling of the power combiners and/or dividers has the same advantages like described before, such as less space consumption than conventional power combiners and/or dividers.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is further described hereinafter with reference to illustrated embodiments shown in the accompanying drawings, in which:

FIG. 1 illustrates a perspective view of a power combiner/divider of an assembly in accordance with the present invention, with an internal view of the inner parts of the power combiner/divider;

FIG. 2 illustrates a cross-sectional side view along a longitudinal axis of the power combiner/divider of FIG. 1 with a power combining or dividing part A and an impedance transforming part B;

FIG. 3 illustrates a cross-sectional view from above along a longitudinal axis of the power combiner/divider of FIG. 1; and

FIG. 4 is a flowchart of the method in accordance with the invention.

### DETAILED DESCRIPTION OF THE EXEMPLARY EMBODIMENTS

A power combiner/divider of an assembly in accordance with the present invention in a perspective view is shown in FIG. 1. The internal view to the inner parts of the power combiner/divider is enabled by leaving out a part of the outer casing 5. The power combiner/divider has the shape of a rectangular box, with multiple connectors for RF-power 1 on one side, and a connector for RF-power 4 on the opposite side of the box shaped casing 5. This arrangement is one possible embodiment, other arrangements are not shown in the FIG. 1 for purposes of simplicity.

Inside the casing 5, a flat center conductor 2 is arranged parallel to the ground plane of the box shaped casing 5. The center conductor 2 is directly connected in an electrically conductive manner to the connector for RF-power 4. The multiple connectors for RF-power 1 are each electrically conductively connected to the center conductor 2 via conductors 3 inside the box, which have the shape of bent rods with round cross-section.

The box shaped casing 5 is electrically conductive. The outside conductor 5 can be made from a metal sheet, particularly from copper, aluminum or copper plated steel.

Within the center conductor 2 a cooling system can be arranged, particularly a water cooling system. For simplicity, no cooling system is shown in the figure. Waste heat from the center conductor 2 can be removed to the outside of the power combiner/divider.

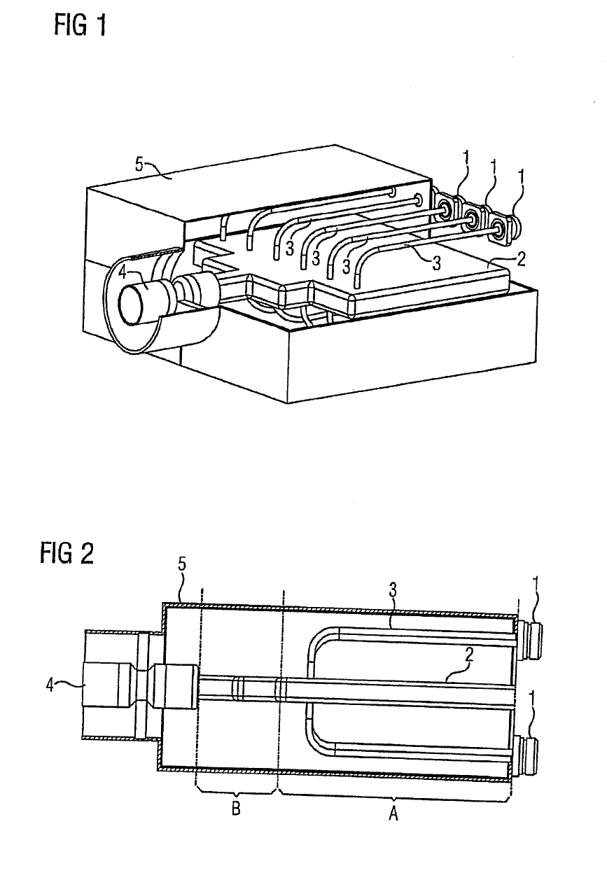

FIG. 2 illustrates a sectional side view along a longitudinal axis of the power combiner/divider. On the left side, the connector for RF-power 4 is arranged at the case 5, electrically connected to the center conductor 2. On the right side of the case 5, a number of connectors for RF-power 1 are arranged in two rows or lines, one row upon the other row. One row of connectors 1 is arranged above the center conductor 2, the second row of connectors 1 is arranged below the center conductor 2. Other numbers and arrangements of connectors 1 and 4, which is not shown in the figure for purposes of simplicity are also possible.

In the embodiment of FIG. 2, the connectors 1 are 50 Ohm coaxial connectors. The connector 4 is a single 50 Ohm connector. The use of other connectors 1 and 4, depending on the application of the assembly of power combiners and/or dividers and the frequency in use is possible.

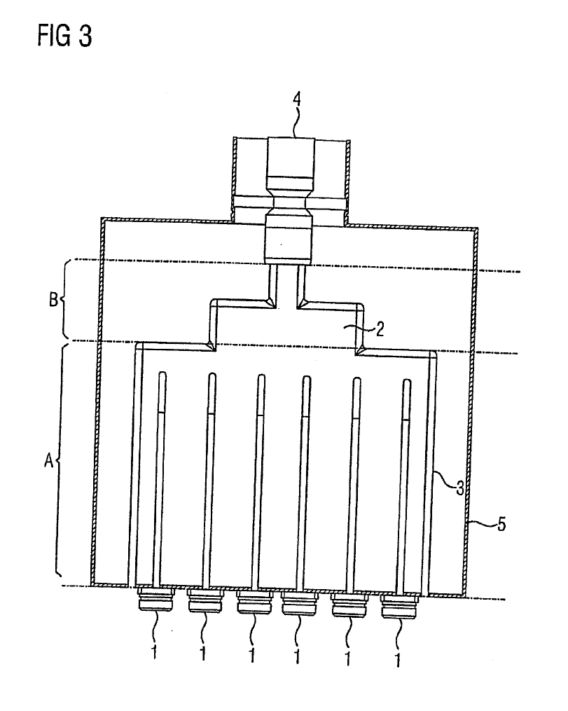

As shown in FIG. 2 in side view and in FIG. 3 in top view, the power combiner/divider comprises a power combining or dividing part A and an impedance transforming part B. The impedance transforming part B is a narrow band or a wideband frequency element. It is a RF matching element for reducing the reflection of RF power, particularly between twelve 50 Ohm coaxial connectors at the one side of the box 5 and a single 50 Ohm connector at the other side.

The impedance transforming part (B) in FIGS. 2 and 3 is an electrical conduction line with outer stepped shape. It can also have a tapered or binomial shape, not shown in the figures for purposes of simplicity. The shape depends on application, power and frequency used, and can be optimized to reduce power loses.

As seen in FIGS. 2 and 3, the 12 connectors for RF-power 1, respectively six in a row or line, next to each other arranged, are electrically connected to the center conductor 2, each by a conductor 3 inside the box 5 in form of a bent rod. The rod can be made of solid copper, aluminum or copper plated steel or other metals. The rods, shown in FIGS. 2 and 3 have a round cross-section. Depending on applications, the rods can also have other cross-sections, such as rectangular or quadratic. The conductors 3 are bent on its long side towards the flat side of the center conductor 3, which is in plate form. Conductors 3 directly connect the connectors 1 with the center conductor 3 mechanically and electrically.

Features described before can be used individually in combination, and in combination with embodiments known from the state of the art. Other materials, such as metals, e.g., gold or silver, semiconductors, or conducting polymers, can be used for all elements such as multiple connectors for RF-power 1, center conductor 2, conductors inside the box 3, connector for RF-power 4 and an outside conductor in form of a box shaped casing 5. The elements can be made of the same or different materials.

The number of multiple connectors for RF-power 1 and the number of connectors for RF-power 4 can be different than the number shown in the present embodiment. For example, there can be more than one connector for RF-power 4, particularly to connect with different output devices receiving RF-power. The center conductor 2 can be in plate form or have another shape, such as a flattened conus. A cooling arrangement can be provided at or in the box 5, particularly in the central conductor 2. The impedance transforming part (B) can have all different shapes, such as curved, waved, or stepped.

Connectors 1 and 4 can be coaxial, rectangular or circular waveguides, or another form. The box 5 can be of cuboid form, a parallelepiped or other forms, such as a flattened conus. There can be elements, not shown in the Figures for purposes of simplicity, to fix and arrange parts together.

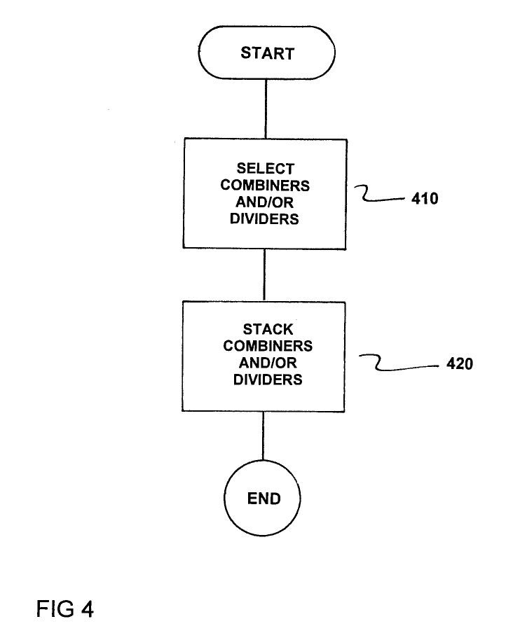

FIG. 4 is a flowchart of a method for utilizing an assembly for radio-frequency (RF) power coupling comprising at least one box shaped power combiner and/or divider, at least one center conductor (2), connectors (1, 4) for inputting and outputting RF-power, conductors (3) arranged inside the at least one box shaped power combiner and/or divider and electrically connecting the connectors (1) with the at least one center conductor (2), and at least one outside conductor (5) formed as a box shaped casing.

The method comprises selecting box shaped power combiners and/or dividers, as indicated in step 410. Next, the selected box shaped power combiners and/or dividers are stacked, as indicated step 420. In accordance with the method of the invention, the box shaped power combiners and/or dividers are stacked in 19-inch racks either next to or on top of each other.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. An assembly for radio-frequency (RF) power coupling, comprising:
at least one box shaped power combiner and/or divider;
at least one center conductor;
connectors for inputting and outputting RF-power;
conductors arranged inside the at least one box shaped power combiner and/or divider and electrically connecting the connectors with the at least one center conductor; and
at least one outside conductor formed as a box shaped casing.

15. The assembly according to claim 14, wherein the box shaped casing is a parallelepiped, particularly a cuboid.

16. The assembly according to claim 15, wherein the parallelepiped is a cuboid.

17. The assembly according to claim 14, wherein at least one of (i) parts and (ii) all parts of the at least one box shaped power combiner and/or divider are made of solid metal pieces comprising at least one of (i) copper, (ii) aluminum and (iii) copper coated steel.

18. The assembly according to claim 15, wherein at least one of (i) parts and (ii) all parts of the at least one box shaped power combiner and/or divider are made of solid metal pieces comprising at least one of (i) copper, (ii) aluminum and (iii) copper coated steel.

19. The assembly according to claim 14, wherein the at least one box shaped power combiner and/or divider comprises at least one power combining or dividing part (A) and at least one impedance transforming part (B).

20. The assembly according to claim 19, wherein the impedance transforming part (B) is a narrow band or wideband frequency element.

21. The assembly according to claim 19, wherein the impedance transforming part (B) is a RF matching element for reducing RF power reflections between multiple 50 Ohm coaxial connectors at one side and a single 50 Ohm connector at another side of the at least one box shaped power combiner and/or divider.

22. The assembly according to claim 20, wherein the impedance transforming part (B) is a RF matching element for reducing RF power reflections between multiple 50 Ohm coaxial connectors at one side and a single 50 Ohm connector at another side of the at least one box shaped power combiner and/or divider.

23. The assembly according to claims 19, wherein the impedance transforming part (B) is an electrical conduction line having one of an outer stepped, tapered or binomial shape.

24. The assembly according to claim 14, wherein the at least one box shaped power combiner and/or divider comprises at least one of (i) at least one coaxial, (ii) at least one rectangular waveguide and (iii) at least one circular waveguide connector.

25. The assembly according to claim 14, wherein the at least one box shaped power combiner and/or divider has substantially a dimension of a 19-inch rack having a module front panel wide of 482.6 mm.

26. The assembly according to claim 14, wherein the at least one box shaped power combiner and/or divider comprises at least one fluid cooling device

27. The assembly according to claim 16, wherein the at least one fluid cooling device is a water cooling device.

28. The assembly according to claim 14, wherein the at least one center conductor is formed as a flat plate arranged parallel to a ground plane of the at least one box shaped power combiner and/or divider.

29. The assembly according to claim 14, wherein the conductors arranged inside the at least one box shaped power combiner and/or divider, electrically connecting the connectors with the at least one center conductor, are formed as solid bent rods having at least one of (i) round and (ii) rectangular cross-sections.

30. A method for utilizing an assembly for radio-frequency (RF) power coupling comprising at least one box shaped power combiner and/or divider, at least one center conductor, connectors for inputting and outputting RF-power, conductors arranged inside the at least one box shaped power combiner and/or divider and electrically connecting the connectors with the at least one center conductor, and at least one outside conductor formed as a box shaped casing, the method comprising:
selecting box shaped power combiners and/or dividers; and
stacking the selected box shaped power combiners and/or dividers;
wherein the box shaped power combiners and/or dividers are stacked in 19-inch racks at least one of (i) next to and (ii) on top of each other.
